(19) United States
(12) Patent Application Publication
(10) Pub. No.: US 2022/0383218 A1
(43) Pub. Date: Dec. 1, 2022

(54) SYSTEMS AND METHODS FOR PRODUCT OVERSIGHT

(71) Applicant: SKYJED PTY LTD, Redfern, New South Wales (AU)

(72) Inventors: Leica ISON, Redfern (AU); Stephen BROWN, Redfern (AU)

(21) Appl. No.: 17/772,286

(22) PCT Filed: Oct. 22, 2020
(86) PCT No.: PCT/AU2020/051138

§ 371 Date: Apr. 27, 2022

(30) Foreign Application Priority Data
Oct. 30, 2019 (AU) 2019904081

(51) Int. Cl. G06Q 10/06

(52) U.S. Cl. CPC G06Q 10/0637; G06Q 10/0639; G06Q 10/0635

(57) ABSTRACT

Embodiments of the present disclosure provides product oversight systems and methods for assessing health of a product by aggregating domain driver weighted ratings and scores which determines a health-check index of the product at any life stage with a view of achieving overall sustainable growth of product value from organic product strategy outcomes. The health-check index comprises an aggregated weighted rating of the domain drivers. The health-check index may be aggregated at the product, portfolio, and business unit level. The product oversight system enables standardization of a domain driver ratings and overall health-check index.

### TECHNICAL FIELD

The presently disclosed subject matter generally relates to the field of product lifecycle management. Particularly, the present subject matter relates to product oversight systems and methods for assessing health of a product by aggregating the domain driver weighted ratings and scores which determines a health-check index of the product at any life stage. The health-check index may be aggregated at the product, portfolio, and business unit level with a view of achieving overall sustainable growth of product value from organic product strategy outcomes.

### BACKGROUND

Any references to methods, apparatus or documents of the prior art are not to be taken as constituting any evidence or admission that they formed, or form part of the common general knowledge.

Product lifecycle management as a theory emerged in the 1950s and gained acceptance in early 1960s and has continued to be the popular reference in business and academic circles to decide on improving product performance using a reference of lifecycle stage.

Businesses decision making for life-of-product oversight usually consists of adopting the framework called Product Lifecycle Management PLM. Product Life Cycle Theory, which gained momentum in 1960, with Levitt's conception in his Harvard Business Review paper “Exploit the product life cycle”. In 1965; the main elements of this, and indeed the whole theory PLM tracked products through four predictable in market phases that includes introduction, product growth, product maturity, and decline. These stages and the diagram of time and sales axis with the life-stage curve are still widely recognized and referred to: Stage 1—Market Development—new product enters the market where demand low and sales are low; Stage 2—Market Growth—demand begins to accelerate and market size increases; Stage 3—Market Maturity-demand levels off; and Stage 4—Market Decline—product sales decline. This theory has remained static for over 60 years and is still commonly referred to by product and technology-based businesses as the framework they use to manage their products post-launch. Today, this concept remains at the center of most firms' marketing and product positioning strategies, used to manage the methodical progress of their offerings from introduction and growth to maturity and decline.

Classical PLM centered around the pain point for business and organization decision-makers to have a disciplined framework to determine the successes or failure of individual product strategy when introduced into market and to support decisions of when to invest to enhance the product, when to pull the pricing lever and change pricing relative to competitive activities or change strategy and decommissioning of the product. Despite this, the failure rate of new product development remains high. As mentioned in the Product Management Trends & Benchmark Report 2019. Product Management Festival product leaders indicate they make strategic decisions largely based on gut feel and past experience and spend less than 11% of their activity time on strategic activity (vision and strategy).

Now and increasingly so in the future, the rate of change and factor cycles to predict and assess change on product strategy goals will become critical. Since the 1960s, the need to review and reassess product strategy has changed, and the cadence has moved from one-off quarterly or annual business activity to a need for continual real-time business activity. Business leaders need to be able to review and report with tighter cadence and the time to conduct the review also becomes critical to keep the product strategies on track.

More recently, Lean or Agile product management has gained momentum globally, adopting the Scrum as a management process that focusses on software development using incremental and empirical methods. The model uses teams and open communication—often verbal not written. In Agile, the product development occurs in iterations, called sprints and is based on Agile Manifesto and its 12 principles centering around people, products and communication for successful product development and innovation.

Agile/Scrum/Kanban/Sprints are widely adopted by businesses and organization to support new product development. Despite this, the frameworks for managing product post-launch have remained static. The disadvantages of the PLM framework include; sales are used as a predictor product life stage; it's difficult to determine when moving between phases; the framework does not address risk management; the framework does not address regulatory obligations; primarily monitor non-financial metrics given the two-dimension are time and sales without incorporating operational and non-financial metrics and risks.

Further, there exists systems and methods for project delivery management based on factors and abstract factors for delivery methods such as, innovation, complexity, flexibility, uncertainty, integrity, marketability, economic feasibility etc. Such systems and methods can only be implemented in construction/building/infrastructure industry. Further, life stage process of plan and program, design, contract, construction, operation and maintainer in the method for methods for project delivery management is an end-to-end delivery process. Also there exists systems and methods for internal evaluation of an organization's program management based on critical performance area and subfactors that may be determined or collected by using survey tools similar to a performance review survey. These systems and methods may be used for evaluation process for business programs or construction delivery—but they might not be useful to determine how these may influence the creation of risk mitigation or strategic growth plans.

Other prevailing framework systems for product oversight only capture a point in time and do not continually capture the growth trajectory of product strategy, which promotes timely strategy resolution to reach the desired outcome. None of them demonstrate an ability to assess current and future target market environments e.g. consumer, business, wholesale and peer to peer for the purpose of generating future sustainable growth and business value.

In light of above discussion, there exists a need for improved techniques for product oversight and product lifecycle management.

### SUMMARY

To overcome the above-mentioned limitations and problems, the present disclosure provides product oversight systems and methods for assessing health of a product by aggregating domain driver weighted ratings and scores which determines a health-check index of the product at any life stage with a view of achieving sustainable growth of product value from organic product strategy outcomes. The health check index comprises an aggregated weighted rating of the domain drivers. The health-check index may be aggregated at the product, portfolio, and business unit level.

The present disclosure provides a product oversight system for growing and maintaining “Commercialised Products” within “target markets” for the purpose of generating continual sustainable growth and business value e.g. in terms of sales and revenue for an organisation. The product oversight system uses domains and drivers to assess current and future target market environments for the purpose of generating future sustainable growth and business value. The target market environments may include e.g. consumer, business, wholesale and peer to peer market environments.

An embodiment of the present disclosure provides a product oversight system (hereinafter referred as a system) including an input device for receiving a product strategy input, a related outcome input for managing a lifecycle of at least one product, and data comprising a set of domain drivers for product oversight and performance of the at least one product. The system also includes a processing device configured to assign a rating to the data for aggregating a score for each domain driver of the set of domain drivers. The processing device also determines a health-check index of the at least one product based on the analysis and rating of the data, and the score of each domain driver of the set of domain drivers. The processing device may determine the health-check index at the product, portfolio, and business unit level with a view of achieving overall sustainable growth of product value from organic product strategy outcomes. The health-check index may include at least one of a probability that a strategy concerning the at least one product will meet a timeline desired strategy outcome, and a probability that the strategy concerning the at least one product will undergo a life stage event or be subject to risk within a particular period of time. The processing device may also rank the at least one product based on the health-check index of the at least one product. Further, the processing device may also predict a financial and value performance of the at least one product. The processing device may also simulate one or more investment scenarios and innovation actions for the at least one at least one product. The system also includes a risk management device for determining a risk action plan based on at least one of the health-check index, the product strategy input, and the related outcome input, wherein one or more risk mitigation activities are implemented based on the risk action plan and the risk action plan are implemented. The system also includes a strategic management device for determining a strategic action plan based on the health-check index, wherein one or more strategic action activities are implemented based on the strategic action. The system also includes a monitoring device configured to continuously monitor and audit the one or more strategic action activities and the lifecycle of the at least one product to provide continual organic planning enhancements, and monitoring of product domain driver dynamics and product strategy activities to meet a desired output according to the received related outcome input.

According to an aspect of the present disclosure, the set of domain drivers may include at least one of financial drivers, customer engagement drivers, market and competitive drivers, regulatory drivers, industry structure drivers, and historical insights information.

According to another aspect of the present disclosure, the health-check index for the at least one product comprises an aggregated weighted sum of ratings of the domain drivers of the at least one product.

According to another aspect of the present disclosure, the processing device determines the health-check index of the at least one product using a machine learning model being trained using the historical insights information from the product oversight system.

According to another aspect of the present disclosure, the monitoring device is further configured to: monitor the lifecycle of the at least one product to see delta index changes in the health-check index of the at least one product over time; provide a three-dimensional (3D) time-domain view across product domain driver dynamics and product strategy activities; capture and evaluate subjective and non-subjective product knowledge; and determine and provide at least one of an active growth strategy index, a performance feedback of the at least one product, and over performance feedback of the at least one product.

According to another aspect of the present disclosure, the product oversight system also includes a database for storing information about a life stage of the at least one product, a health status comprising the health-check index of the at least one product, a plurality of hygiene factors, one or more domain driver categories with product identified, portfolio data, company data, industry data, the set of domain drivers, the related outcome input, the product strategy input, historical insights information, and the ratings and score of the set of domain drivers.

According to another aspect of the present disclosure, the product oversight system also includes a display device configured to display information comprising the health-check index, the strategic action, and risk action plan.

According to another aspect the present disclosure, the strategy management device is further configured to determine an active strategy index.

According to yet another aspect of the present disclosure, the risk management device is further configured to check if the product is meeting product regulatory obligations and other risks and accordingly provide a baseline of regulatory compliance at product level.

Another embodiment of the present disclosure provides a method for product oversight by using a product oversight system. The method includes receiving, by an input device of the product oversight system, a product strategy input, a related outcome input for managing a lifecycle of at least one product, and data comprising a set of domain drivers for product oversight and performance of the at least one product. The method also includes assigning, by a processing device of the product oversight system, a rating to the data for aggregating a score of each domain driver of the set of domain drivers. The method further includes determining, by the processing device, a health-check index of the at least one product based on the analysis and rating of the data, and the score of each domain driver of the set of domain drivers. The health-check index is determined at the product, portfolio, and business unit level with a view of achieving overall sustainable growth of product value from organic product strategy outcomes. The health-check index may include at least one of a probability of a strategy concerning the at least one product will meet a timeline desired strategy outcome and a probability that the strategy concerning the at least one product will undergo a life stage event or be subject to risk within a particular period of time. The method also includes ranking, by the processing device, the at least one product based on the health-check index of the at least one product. The method also includes predicting, by the processing device, a financial and value performance of the at least one product. The method further includes simulating, by the processing device, one or more investment scenarios and innovation actions for the at least one at least one product. The method further includes determining, by a risk management device of the product oversight system, a risk action plan based on at least one of the health-check index, the product strategy input, and the related outcome input, wherein one or more risk mitigation activities are implemented based on the risk action plan. Further, the method includes determining, by a strategic management device of the product oversight system, a strategic action plan based on the health-check index, wherein one or more strategic action activities are implemented based on the strategic action plan. Furthermore, the method includes continuously monitoring and auditing, by a monitoring device of the product oversight system, the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input.

According to an aspect of the present disclosure, the method also includes determining, by the processing device, the health-check index of the at least one product using a machine learning model being trained using the historical insights information from the product oversight system.

According to another aspect of the present disclosure, the method also includes monitoring, by the monitoring device, the lifecycle of the at least one product to see delta index changes in the health-check index of the at least one product over time.

The method may also include providing, by the monitoring device, a three-dimensional (3D) time-domain view across product domain driver dynamics and product strategy activities.

In some embodiments, the method may also include capturing and evaluating, by the monitoring device, subjective and non-subjective product knowledge.

Further, the method may also include determining and providing, by the monitoring device, at least one of an active growth strategy index, a performance feedback of the at least one product, and over performance feedback of the at least one product.

According to another aspect of the present disclosure, the method also includes storing, in a database of the product oversight system, information about a life stage of the at least one product, a health status comprising the health-check index of the at least one product, a plurality of hygiene factors, one or more domain driver categories with product identified, portfolio data, company data, industry data, the set of domain drivers, the related outcome input, the product strategy input, historical insights information, and the ratings and score of the set of domain drivers.

According to another aspect of the present disclosure, the method also includes displaying, by a display device of the product oversight system, display information comprising the health-check index, the strategic action, and risk action plan.

According to another aspect of the present disclosure, the method also includes determining, by the strategic management device, an active strategy index.

According to another aspect of the present disclosure, the method also includes checking, by the risk management deice, if the product is meeting product regulatory obligations and other risks and accordingly providing a baseline of regulatory compliance at product level.

Yet another embodiment of the present disclosure provides a method for product oversight using a product oversight system. The method includes: receiving a product strategy input, a related outcome input for managing a lifecycle of at least one product, and data comprising a set of domain drivers for product oversight and performance of the at least one product; assigning a rating to the data for aggregating a score of each domain driver of the set of domain drivers; determining a health-check index of the at least one product based on the analysis and rating of the data, and the score of each domain driver of the set of domain drivers; determining a risk action plan based on at least one of the health-check index, the product strategy input, and the related outcome input, wherein one or more risk mitigation activities are implemented based on the risk action plan; determining, by a strategic management device of the product oversight system, a strategic action plan based on the health-check index, wherein one or more strategic action activities are implemented based on the strategic action plan; continuously monitoring and auditing the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input; predicting a financial and value performance of the at least one product; simulating one or more investment scenarios and innovation actions for the at least one at least one product; and storing information about a life stage of the at least one product, a health status comprising the health-check index of the at least one product, a plurality of hygiene factors, one or more domain driver categories with product identified, portfolio data, company data, industry data, the set of domain drivers, the related outcome input, the product strategy input, historical insights information, the ratings and score of each domain driver of set of domain drivers.

According to an aspect of the present disclosure, the set of domain drivers comprising at least one of financial drivers, customer engagement drivers, market and competitive drivers, regulatory drivers, industry structure drivers, and historical insights information.

According to another aspect of the present disclosure, the health-check index for the at least one product comprises an aggregated weighted sum of ratings of the domain drivers of the at least one product.

Other and further aspects and features of the disclosure will be evident from reading the following detailed description of the embodiments, which are intended to illustrate, not limit, the present disclosure.

### DETAILED DESCRIPTION

Preferred features, embodiments and variations of the invention may be discerned from the following detailed description which provides sufficient information for those skilled in the art to perform the invention. The detailed description is not to be regarded as limiting the scope of the preceding summary of the invention in any way.

The functional units described in this specification have been labelled as devices or modules. A device or module may be implemented in programmable hardware devices such as CPUs, tensor processors, field programmable gate arrays (FPGA), cloud computation units, distributed computation units, or the like. The devices and modules may also be implemented in software for execution by various types of processors. An identified device or module may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Furthermore, the described features, structures, or characteristics may be combined in any suitable manner in one or more embodiments.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP/S, SOAP, REST, MQTT, RTSP, HLS, TLS, SSL and other sufficient protocols. The disclosed computer programs can be written in complied programming languages that execute from memory on the device or from a hosted server, such a C, C++, Java, or interpreted languages such as JavaScript, Python HTML, CSS, node.js, .net core, Ruby, PHP, Perl, Swift, SQL, or other sufficient programming languages. Other software technologies like, ReactJS/Redux, visual studio code, WebStorm, NPM 4+, PostgreSQL database, DynamoDB, WebSocket, AWS, may be used to develop the disclosed system.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages. Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), content delivery network (CDN), virtual private cloud (VPC) and so forth.

Specific embodiments of the present disclosure are described, by way of example only, with reference to the accompanying drawings, in which:

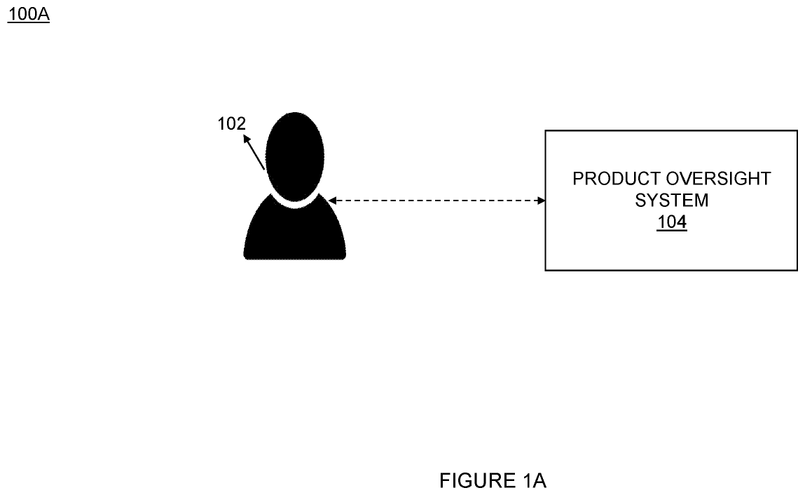

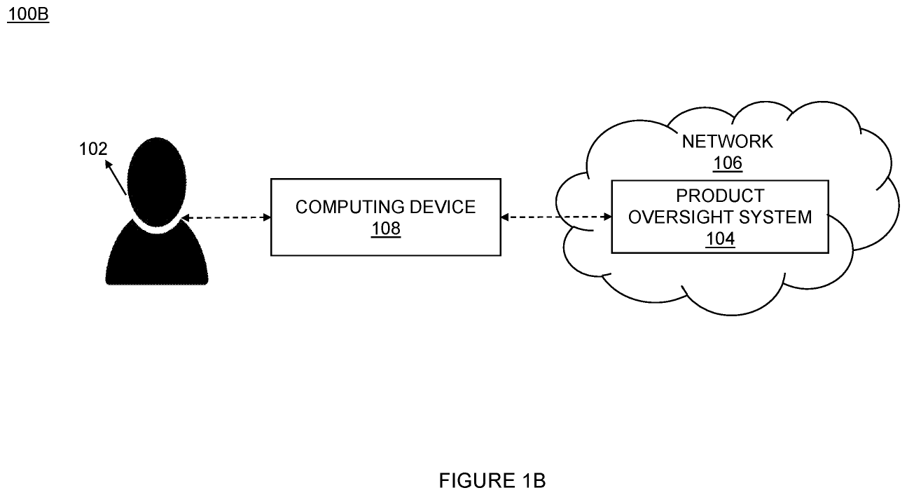

FIGS. 1A-1B are schematic diagrams illustrating exemplary environments, where various embodiments of the present disclosure may function;

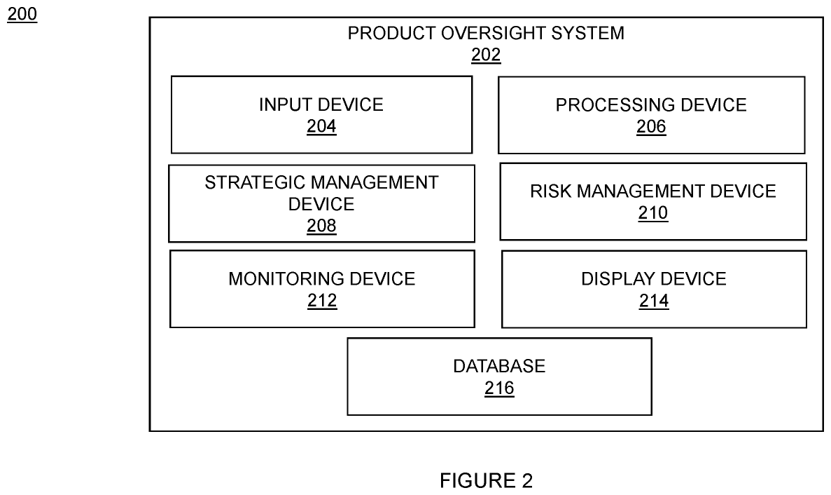

FIG. 2 is a block diagram illustrating various system elements of an exemplary product oversight system, in accordance with an embodiment of the present disclosure;

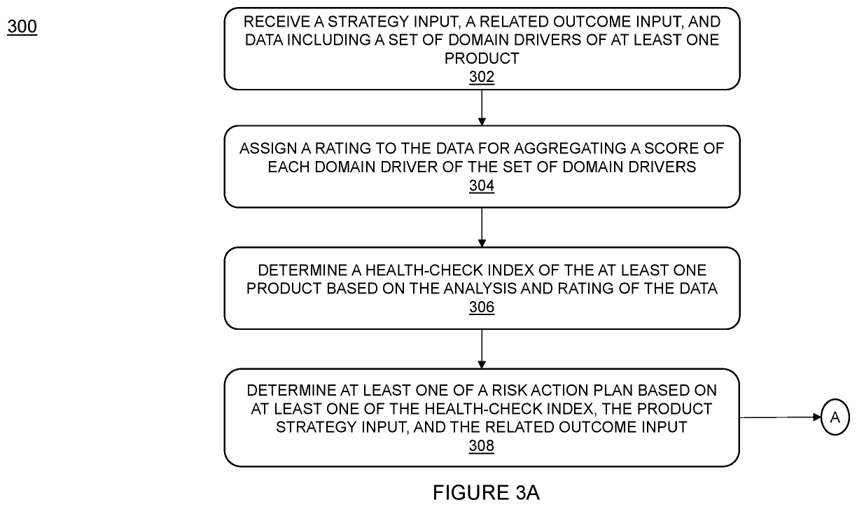

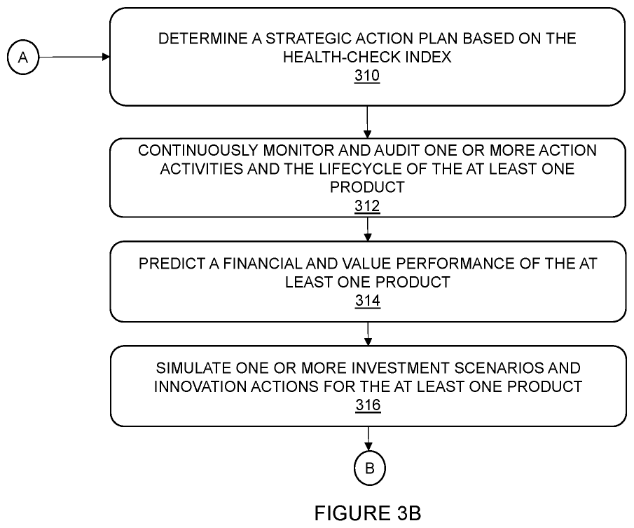

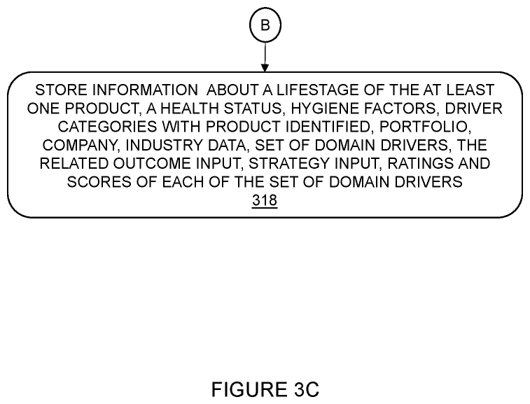

FIGS. 3A-3C are a flowchart diagram illustrating an exemplary method for product oversight, in accordance with an embodiment of the present disclosure; and

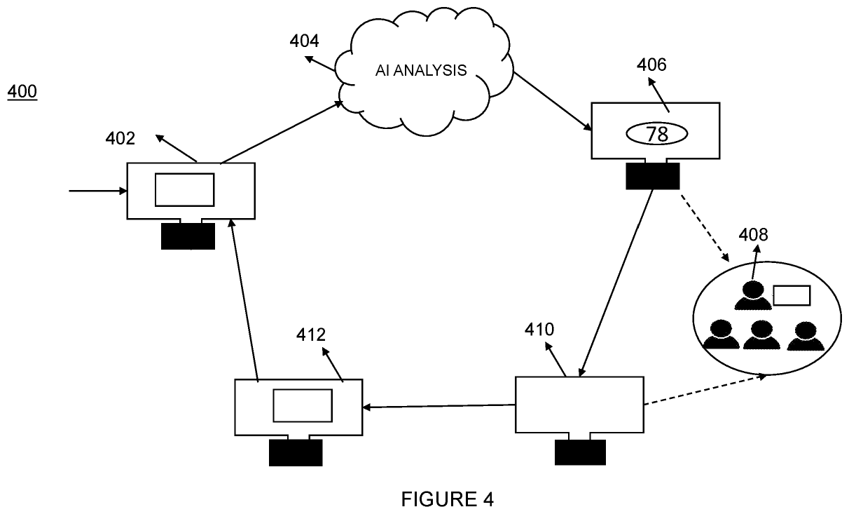

FIG. 4 illustrates an exemplary continuous auditing framework using a product oversight, in accordance with an embodiment of the present disclosure.

As used herein the term “product” refers to a product, an asset, a service, a resource, an object, a project or an item with a desired outcome for value creation.

As used herein the term “health-check index” refers to an aggregated weighted sum of ratings of the domain drivers of the at least one product.

As used herein the term “computing device” refers to an electronic device capable of connecting to a network and also have computational connectivity. Examples of the computing device may include, but are not limited to, a computer, a smart phone, a tablet computer, a laptop computer, a smart television, a smart watch, a fitness tracker, and so forth.

As used herein the term “product oversight system” refers to a system configured to provide a standardized health-check index of the product domain driver dynamics. The health-check index may assist product teams with identifying underperforming product domain drivers, product domain drivers that captures areas of risk, potential strategy growth areas, and so forth. The product oversight system may be a single device or may include multiple devices or modules. Further the product oversight system may include hardware, software, firmware, and combination of these. Further, the product oversight system can be implemented on a computing device or on a network device like a server or in a cloud-based device.

The principal objective of the present disclosure is to provide systems and methods for determining a standardized health-check index of a product based on product domain driver dynamics. The health-check index can be aggregated at the product, portfolio and business unit level with a view of achieving an overall sustainable (or positive) growth of product value from organic product strategy outcomes. The health-check index may assist product teams with identifying underperforming product domain drivers, product domain drivers which capturing areas of risk, potential strategy growth areas etc. Further, the system provides a rating to the data, both qualitative and quantitative. In some embodiments, these ratings are either generated by the users' subjective opinions or an automatic rating (e.g. based on a Key Performance Indicator). Upon submitting a review completed review cycle, the system may use AI processes the ratings along with the ML (machine learning) domain driver weightings to generate the health-check index. The system standardizes the health-check indexes, the index can be aggregated to a product, portfolio and business unit level which can then be monitored holistically or drilled down on to explore areas of interest and improvement. The system identifies an area of risk by either the domain driver score or health-check index. Then, a risk mitigation action item is created and monitored to counteract the identified domain driver directly.

Referring to FIGS. 1A-1B, exemplary environments 100A-100B are illustrated, where various embodiments of the present disclosure may function. As shown in FIG. 1A, the environment 100A includes a user 102, and a product overview system 104. The user 102 may directly access the product oversight system 104.

As shown in the environment 100B in FIG. 1B, the product oversight system 104 is located in a network 106. The user 102 may connect to the network 106 by using a computing device 108 for accessing the product oversight system 104. In some embodiments, the network 106 is a cloud network. The product oversight system 104 may include software, hardware, firmware, and combination of these. In some embodiments, the user 102 may install the product oversight system 104 on the computing device 108. In alternative embodiments, the user 102 accesses the product oversight system 104 by entering a uniform resource locator (URL) or a network address on a browsing application on the computing device 108. Examples of the computing device 108 may include, but are not limited to, a computer, a smart phone, a tablet computer, a smart television, a smart watch, a fitness tracker, a personal digital assistant, a laptop computer, and so forth.

The product oversight system 104 (hereinafter and throughout the terms product oversight system and system may be used interchangeably without change in its meaning) configured to receive one or more inputs comprising such as, but not limited to, a product strategy input, a related outcome input for managing a lifecycle of at least one product, and data comprising a set of domain drivers for product oversight and performance of the at least one product. The set of domain drivers may include at least one of financial drivers, customer engagement drivers, market and competitive drivers, regulatory drivers, industry structure drivers, and historical insights information. Examples of the domain drivers may include, but are not limited to, revenue, value, customer, strategy or regulatory.

The system 104 may assign a rating to the data for aggregating a score of each domain driver of the set of domain drivers. The system 104 may determine a health-check index of the at least one product based on the analysis and rating of the data, and score of each domain driver of the set of domain drivers. The health-check index for the at least one product may include an aggregated weighted sum of ratings of the domain drivers of the at least one product. Further, health-check may comprise of an aggregated weighted rating(s) of the domain drivers.

The health-check index (business model) for each product could be initially hypothesized as an aggregated weighted sum of all the ratings in the form:

$$H = {\sum }_{j = 1}^{n} {k}_{Dj} \frac{{Σ}_{i = 4}^{5} {k}_{ji} {R}_{ji} + \frac{{k}_{j 3} {R}_{j 3}}{2}}{{Σ}_{i = 0}^{5} {k}_{ji} {R}_{ji}}$$

where;

### H—Heath Index

n—number of drivers
j—driver number
k_{Dj}—weighting for given driver
i—rating score
kⱼᵢ—weighting for given driver rating score
Rⱼᵢ—counte of given driver rating score

The system 104 may determine the health-check index at the product, portfolio, and business unit level with a view of achieving overall sustainable growth of product value from organic product strategy outcomes. The health-check index may predict at least one of: a probability that a strategy concerning the at least one product will meet a timeline desired strategy outcome; and a probability that the strategy concerning the at least one product will undergo a life stage event or be subject to risk within a particular period of time.

In some embodiments, the system 104 determines the health-check index of the at least one product using a machine learning model being trained using the historical insights information from the product oversight system 104. Further, the system 104 may be configured to rank the at least one product based on the health-check index of the at least one product.

The system 104 may also be configured to determine a risk action plan based on at least one of the health-check index, the product strategy input, and the related outcome input, wherein one or more risk mitigation activities are implemented based on the risk action plan. The system 104 may also determine a strategic action plan based on the health-check index. The one or more strategic action activities can be implemented based on the strategic action plan.

The system 104 continuously monitors and audits the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input.

The system 104 may monitor the lifecycle of the at least one product to see delta index changes in the health-check index of the at least one product over time. Further, the system 104 may provide a three-dimensional (3D) time-domain view across product domain driver dynamics and product strategy activities. The system 104 may also be configured to capture and evaluate subjective and non-subjective product knowledge. In the concept of 3D modelling of product domain driver dynamics, the following factors inform the decision making to achieve the product strategy outcomes: Time is always the third dimension; The organic product strategy is viewed with any two parameters, e.g. market versus—the Health-check index versus outcomes, side-by-side product comparison; Product—where the user 102 sets the product and strategy or desired outcome; and Product strategy is continuously monitored in time by the system 104.

In some embodiments, the health-check index may predict the likelihood of achieving (or not achieving) forecasted values such as forecast revenue, but this likelihood could be counter corrected by setting and completing strategy and risk mitigation action items. In some embodiments, the system 104 may use machine learning (ML) and artificial intelligence (AI) to predict product domain driver values. For example, use revenue trends, health index trends and strategy/risk mitigation action trends to more accurately forecast the likely revenue generated by a product.

FIG. 2 is a block diagram 200 illustrating various system elements of an exemplary product oversight system 202, in accordance with an embodiment of the present disclosure. As shown, the product oversight system 202 includes an input device 204, a processing device 206, a strategic management device 208, a risk management device 210, a monitoring device 212, a display device 214, and a database 216. The product oversight system 202 is shown to include seven devices or modules, but a person ordinarily skilled in the art will understand that the product oversight system 202 may include more or less than seven devices or modules. Further, the devices 204-216 may be connected to each other and are configured to share data and output with each other.

The product oversight system 202 may improve the achievement of product strategy goals through an algorithm in a health-check index. The product may include any suitable product with the desired outcome for value creation. Examples of the product may include such as, but are not limited to, an asset, a service, a resource, an object, a project, or an item. The product oversight system 202 may provide continual organic planning enhancements and monitoring of product domain driver dynamics and product strategy activities to meet the desired outcomes. Further, the product oversight system 202 (hereinafter may also be referred as system 202) may provide a 3D time-domain view across product domain driver dynamics and product strategy activities. The system 202 may fit or may be used in all life span or phases of a product or asset. The system 202 is not navigated by a pre-determined set of static stages. The system 202 enables the capture and evaluation of subjective and non-subjective product knowledge. The system 202 may improve the growth trajectory towards its product strategy goal and adopting a framework to pragmatically identify strategy disruptions or challenges and actively course correct the strategy. Instead of fitting an organic product into a fixed formula of stages based on time and sales/revenue dimension, the system 202 may set the desired timeline outcomes by capturing the product domain driver dynamics and determine the strategic activities. Further, the system 202 may continuously monitor and enhance the strategy for the life of the product.

The input device 204 is configured to receive a product strategy input, a related outcome input for managing a lifecycle of at least one product, and data comprising a set of domain drivers for product oversight and performance of the at least one product. In some embodiments, the input device 204 may be configured to receive any other input from a user or other system or device. The input device 204 may include software, hardware, firmware, or combination of these.

The processing device 206 is configured to assign a rating to the data for aggregating a score of each domain driver of the set of domain drivers. The set of domain drivers may include at least one of financial drivers, customer engagement drivers, market and competitive drivers, regulatory drivers, industry structure drivers, and historical insights information. The processing device 206 may determine a health-check index of the at least one product based on the analysis and rating of the data, and score of each domain driver of the set of domain drivers. The health-check index for the at least one product may include an aggregated weighted sum of ratings of the domain drivers of the at least one product. The processing device 206 may include software, hardware, firmware, or combination of these.

In some embodiments, the processing device 206 determines the health-check index at the product, portfolio, and business unit level with a view of achieving overall sustainable growth of product value from organic product strategy outcomes. The health-check index may predict a probability that a strategy concerning the at least one product will meet a timeline desired strategy outcome. Further, the health-check index may predict a probability that the strategy concerning the at least one product will undergo a life stage event or be subject to risk within a particular period of time. In some embodiments, the processing device 206 determines the health-check index of the at least one product and/or the prediction is performed using a machine learning model that is trained using the historical insights information from the product oversight system 202. For example, the product management system retrieves a list of other users who have experienced similar changes in hygiene factors.

In some embodiments, the processing device 206 is further configured to rank the at least one product based on the health-check index of the at least one product. Further, the processing device 206 may be configured to predict a financial and value performance of the at least one product. The processing device 206 may simulate one or more investment scenarios and innovation actions for the at least one at least one product.

The risk management device 210 is configured to determine a risk action plan based on at least one of the health-check index, the product strategy input, and the related outcome input, wherein one or more risk mitigation activities are implemented based on the risk action plan. In some embodiments, the risk management device 210 may check if the product is meeting product regulatory obligations and other risks and accordingly provide a baseline of regulatory compliance at product level. The risk management device 210 may be configured to monitor or check the regulatory and risk aspects associated with a product for product trust monitoring and outcomes. The risk management device 210 may include software, hardware, firmware, or combination of these.

The strategic management device 208 is configured to determine a strategic action plan based on the health-check index, wherein one or more strategic action activities are implemented based on the strategic action plan. In some embodiments, the strategic management device 208 may determine an active strategy index. In some embodiments, the combined output of the strategic management device 208 and the risk management device 208 counteracts or compensates the health-check index. The strategic management device 208 may include software, hardware, firmware, or combination of these.

The monitoring device 212 is configured to continuously monitor and audit the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input. The monitoring device 212 is further configured to monitor the lifecycle of the at least one product to see delta index changes in the health-check index of the at least one product over time. The monitoring device 212 may provide a three-dimensional (3D) time-domain view across product domain driver dynamics and product strategy activities; and capture and evaluate subjective and non-subjective product knowledge. Further, the monitoring device 212 may determine and provide at least one of an active growth strategy index, a performance feedback of the at least one product, and over performance feedback of the at least one product. The monitoring device 212 may include software, hardware, firmware, or combination of these.

The database 216 stores information about a life stage of the at least one product, a health status comprising the health-check index of the at least one product, a plurality of hygiene factors, one or more domain driver categories with product identified, portfolio data, company data, industry data, the set of domain drivers, the related outcome input, the product strategy input, historical insights information, and the ratings and score of the set of domain drivers. The database 216 may include software, hardware, firmware, or combination of these.

The display device 214 displays information comprising the health-check index, the strategic action, and risk action plan. The display device 214 may include software, hardware, firmware, or combination of these.

A person ordinarily skilled in the art will understand and appreciate that one or more devices or functionality of the one or more devices of the system 202 may be combined into one device. Further, the system 202 may include more or less devices than that shown in the FIG. 2.

FIGS. 3A-3C are a flowchart diagram illustrating an exemplary method for product oversight, in accordance with an embodiment of the present disclosure. At step 302, a product oversight system, such as the product oversight system 202 of FIG. 2, receives one or more inputs such as, but not limited to, a product strategy input, a related outcome input for managing a lifecycle of at least one product, and data comprising a set of domain drivers for product oversight and performance of the at least one product. The set of domain drivers may include at least one of financial drivers, customer engagement drivers, market and competitive drivers, regulatory drivers, industry structure drivers, and historical insights information. In some embodiments, the input device 204 receives the one or more inputs.

At step 304, the system 202 assigns a rating to the data for aggregating a score of each domain driver of the set of domain drivers. In some embodiments, the processing device 206 assigns the rating to the data for aggregating the score of each domain driver of the set of domain drivers.

At step 306, the system 202 determines a health-check index of the at least one product based on the analysis and rating of the data, and the score of each domain driver of the set of domain drivers. The health-check index may be determined by aggregating a weighted sum of ratings of the domain drivers. The health-check index may be determined at the product, portfolio, and business unit level with a view of achieving overall sustainable growth of product value from organic product strategy outcomes. In some embodiments, the health-check index may indicate a probability of a strategy concerning the at least one product will meet a timeline desired strategy outcome, and a probability of that the strategy concerning the at least one product will undergo a life stage event or be subject to risk within a particular period of time. In some embodiments, the system 202 may determine the health-check index of the at least one product using a machine learning model being trained using the historical insights information from the product oversight system 202. In some embodiments, the processing device 206 determines a health-check index of the at least one product based on the analysis and rating of the data, and the score of each domain driver of the set of domain drivers.

Then at step 308, the system 202 determines a risk action plan based on at least one of the health-check index, the product strategy input, and the related outcome input, wherein one or more risk mitigation activities are implemented based on the risk action plan. In some embodiments, the risk management device 210 determines the risk action plan.

At step 310, the system 202 determines a strategic action plan based on the health-check index, wherein one or more strategic action activities are implemented based on the strategic action plan. In some embodiments, the strategic management device 208 determines the strategic action plan.

Then at step 312, the system 202 continuously monitors and audits the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input. The system 202 may also check or monitor the regulatory and risk aspects for product trust monitoring and outcomes. The system 202 may also check if the product is meeting product regulatory obligations and other risks to provide a baseline of regulatory compliance at product level. In some embodiments, the monitoring device 212 continuously monitors and audits the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input.

At step 314, the system 202 predicts a financial and value performance of the at least one product. In some embodiments, the processing device 206 predicts the financial and value performance of the at least one product. Then at step 316, the system 202 simulates one or more investment scenarios and innovation actions for the at least one at least one product. In some embodiments, the processing device 206 simulates the one or more investment scenarios and innovation actions for the at least one at least one product.

At step 316, the information about a life stage of the at least one product, a health status comprising the health-check index of the at least one product, a plurality of hygiene factors, one or more domain driver categories with product identified, portfolio data, company data, industry data, the set of domain drivers, the related outcome input, the product strategy input, historical insights information, and the ratings and score of the set of domain drivers are stored in the database 216 of the system 202.

FIG. 4 illustrates an exemplary continuous auditing framework 400 showing various steps of auditing a product using a product oversight system, in accordance with an embodiment of the present disclosure. To predict an achievement of product strategy and the health of product asset within a business system for a user of product oversight system such as launch, scale, growth, sunsetting or exit, the disclosed product oversight system generates a set of data comprising of historical data that other uses have gone through a product life stage event. The data may be based on an assessment algorithm, insights, scoring, ratings and health status of products.

The product oversight system (hereinafter, may also be referred as a system) may use the framework and data to generate an algorithm using machine learning. Additionally, the system uses the inputted data into a health-check algorithm to generate a prediction on the product strategy goal, risks and opportunities. Furthermore, the system may guide the user through strategic assessment of the health of product and highlights potential pathways for product strategy. The system uses the framework and data to generate an algorithm using machine learning. Additionally, the system uses the inputted data into a health-check algorithm to generate a prediction on the product strategy goal, risks and opportunities. Furthermore, the system guides the user through strategic assessment of the health of product and highlights potential pathways for product strategy.

Furthermore, the system inputs the user data to the prediction algorithm to retrieve a prediction of whether the product has risks or gaps in underlying product business model. The system rates the sustainability of the product in the current system environment. The system guides the user though an assessment of their product based on life stage event and recommends pathways. Rather than merely relying on a system from 1960s, data analytics or non-holistic drivers in determining product strategy, embodiments of the present disclosure predict product life stage events for the user based on the information available about holistic set of product hygiene factors and the inter-relationships with the business system.

As shown at step 402, teams of people like a product management teams may audit a product lifecycle by using the product oversight system and data is stored in database of the product oversight system. The database may be a local database or may be located at a remote location.

The product oversight system or a processing device of the product oversight system may analyze the product domain drivers' data using Artificial Intelligence (AI) as shown at step 404. Then the product oversight system may generate product health and risk insight at step 406. Then either the product oversight system may report and share the insight and action plan with stakeholders at step 408, or the product oversight system may collaborate and build a product action plan at step 410.

Then, the product oversight system may continuously monitor the status of the action plan at step 412. The product oversight system then may continuously monitor and enhance the strategy for the life of the product. Hence, the process continues to step 402. With the continuity of this auditing framework 400, the lifetime of product knowledge is captured, evaluated and informed strategy or risk mitigation action items are set. At each evaluation cycle, the health-check index is stored to also enable future machine learning on the product trends, forecast likelihood and counter correction by setting and completing strategy and risk mitigation action items. The product oversight system is a continuous auditing/continuous monitoring framework for product strategy. By incorporating the product heath checking within this framework, index changes from a high level through to a driver level can monitored. The index and ratings can also assist with identifying areas of risk and requiring risk mitigation actions to be set.

A product life stage and health status event, for example, may be change in margin compression, technology shift, regulatory change, new market entrant or industry structure, just to name a few. Beyond simply relying on historical commercial performance typically used in product analytics, the described approach is better able to use all the information contained in product and business system such as market, competitor, commercial, customer experience and innovation to predict product life stage and health status.

Predicting the health of product may allow system owners and user to suggest options, simulate risks and opportunities that may be relevant to innovation, investment or exit of a product or product portfolio and potential for business model disruption. For example, a product user can produce health-check audit and may make collaborate with business users to make better product strategy decisions and pathways to course correct in response to articulated system characterizes and changes.

In one embodiment the health-check predicts the probability that the product will undergo a life stage event or be success to risk within a particular period of time. In one embodiment, this prediction is performed using a machine learning model that is trained using historical information from the business system. For example, the product management system retrieves a list of other users who have experienced similar changes in hygiene factors.

The veracity of the data may be corrected through a continuous review cycle and the monitoring of the health-check index over time. For example, a product manager completes quarterly product reviews using the disclosed product oversight system and in the first review forecasts $500,000 in annual revenue and failed to rate the correct impact of a competitor in the review. The revenue actuals are 30% below budget and forecast. The follow-up review may identify that the forecast is inaccurate and the health-check index picks that up as a risk and identifies that the competitor is performing better than anticipated.

The disclosed product oversight system may build capability in the team, handover knowledge and uplift the product lifecycle and risk decision-making. The system may also enable the user to invite independent experts to do a peer review of the product audit and self-assessments.

The primary purpose of the disclosed product oversight system is to improve the growth trajectory towards product's product strategy goal and adopting a framework to pragmatically identify strategy disruptions or challenges and actively course correct the strategy. Instead of fitting an organic product into a fixed formula of stages based on time and sales/revenue dimension, the system sets the desired timeline outcomes by capturing the product domain driver dynamics and determining the strategic activities. The system then may continuously monitor and enhance the strategy for the life of the product.

The present disclosure provides a system and a method for health-check of a product based on product domain driver dynamics to provide a standardized index for comparing and monitoring product performance. Within the time domain, a 3D model of product performance across the domain drivers, the health-check index, and between other products can provide improved insight on past performance, enhance strategic planning and increase the accuracy of forecasting. Hence improve the value derived from enhanced product growth.

The disclosed systems and methods improve the efficiency of conducting the product strategy review and uses the framework in two pragmatic ways. The disclosed systems and methods improve the governance and disciplines of undertaking a review. Traditional methods adopt an annual review, and this is not effective in complex, fast-changing ecosystems that are evident today.

The disclosed systems and methods reduce the time it takes to complete a comprehensive review of an organic product strategy—in the past, this was a long time involved to gather the data and insights.

The disclosed systems and methods provide a broader perspective of the product domain driver dynamics by incorporating more than sales/revenue as the main factors in the model. These factors are clustered as operational, financial and non-financial domains and resulting risk factors.

The disclosed systems enable standardization of a domain driver ratings and overall health-check index. Further, the system may compare other product and provides standardized visibility on how the product performing relative to strategy rather than life phase.

The disclosed system is configured for risk mitigation management. The risk mitigation counteracts the impact domain driver threat, such as regulatory, could have had on the desired outcome. For example, when a domain driver is rated poor—by enhancing and actioning the domain driver's risk mitigation strategy, the growth trajectory towards the outcome can be maintained.

The disclosed system may be used for product centric governance of ESG (i.e. environmental, social and governance impacts).

The disclosed system is an organic product strategy framework which is not based on a predicted state on the curve that consistent of 2 dimensions, i.e. time and sales revenue it is in as is the case in PLM. In the Organic product strategy desired outcome success is derived from continuous review and monitoring, health evaluation and strategic course-correction. The system uses variable cadence interval for a reassessment of product domain driver dynamics to determine product health-check index; to suited sophisticate, fast-changing external conditions in the product ecosystem. The system is configured to set strategic growth actions or risk mitigation to course correct the growth trajectory towards the desired outcome. The system provides Timely response to unforeseen disruption and opportunity. The system is also configured to track delta product health changes and outcome. The system continuously reviews cycle for the entire life of the product. The system is configured to generate 3D model of product domain driver dynamics to understand the past and predict the future.

The present disclosure provides a closed-loop control system style method, in which the strategic goal or target that is relevant in all stages of product or asset life span, e.g. innovation or discovery, entry, and exit. The user can vary the reassessment cadence interval of the domain driver dynamics and health-check index and as such, may suit to sophisticate, fast-changing external conditions in the product ecosystem.

The disclosed product oversight system is configured to determine a health-check index of a plurality of products by aggregating a weighted sum of domain drivers associated with the plurality of products. In some embodiments, the health-check index predicts the probability of that the strategy concerning a product will meet a timeline desired strategy outcome or undergo a life stage event or be subject to risk within a particular period of time. In one embodiment, this prediction is performed using a machine learning model that is trained using historical information from the product oversight system. For example, the product oversight system retrieves a list of other users who have experienced similar changes in hygiene factors.

By determining the heath check index, the products can be ranked based upon their health-check index or can be monitored to see its delta index changes over time. By grouping the domain drivers (e.g. revenue, value, customer, strategy or regulatory) it is also possible to rank products these domain drivers to monitor and compare key areas. By grouping the drivers by their category (revenue, value, customer, strategy or regulatory) it is also possible to rank products by category or monitor these too over time.

Successful product growth is driven by a magnitude of financial and non-financial variants across customer, commercial, technology and innovation product domain driver categories. The product oversight system captures these leading and lagging quantitative and qualitative product domain drivers to establish a product domain driver model which is consistent across product and may be computable by data processing systems. The disclosed product oversight system may be able to explore big data insight, AI and machine learning capabilities to better understand current product health, risk and growth and improve the predictable future product growth. Furthermore, with these enhanced product insights, product teams and product stockholder will be able to generate an AI formulated product health-check index, priorities business decision, action key task and track product domain driver changes.

The health-check index will provide the data required to by machine learning to improve the future product growth predictions. In addition, the health-check index may indicate the likelihood of achieving (or not achieving) forecasted values such as forecast revenue, but this likelihood could be counter corrected by setting and completing strategy and risk mitigation action items. Hence, it could be possible to also use ML and AI to predict product domain driver values. For example, use revenue trends, health-check index trends and strategy/risk mitigation action trends to more accurately forecast the likely revenue generated by a product.

The disclosed product oversight system provides life-of-product oversight to improve the achievement of product strategy goals through an algorithm in a health-check index of the product. The product can be a product, an asset, a service, a resource, an object, a project or an item with the desired outcome for value creation.

Further, the disclosed product oversight system can be used for risk estimation” and determining probability of specific deadlines, performance, regulatory and compliance impacts, capacity, and market trends. The system then may use this information for generating future sustainable growth within target markets and may not use it for business program evaluation or construction delivery.

The disclosed product oversight system is an auditing system configured to provide continual organic planning enhancements and monitoring of product domain driver dynamics and product strategy activities to meet the desired outcomes. The disclosed system also provides a 3D time-domain view across product domain driver dynamics and product strategy activities. The system fits all life span or phases of a product or asset and may be used to monitor a product in any phase of product lifecycle. Further, the disclosed system is not navigated by a pre-determined set of static stages. The system may enable the capture and evaluation of subjective and non-subjective product knowledge

The disclosed product oversight system receives a desired outcome that may be set based on a strategy director or goal. Then the system generates an index i.e. a health-check index of the potential and risk to meet. The system sets strategic and risk actions to mitigate risk and value capture opportunity that is weighted into the monitoring and compared back to the implementation of the action.

The disclosed product oversight system has many advantages like the system may provide a complete picture of the product lifecycle by using and analyzing a range of inputs comprising financial, operational, and non-financial. Further, the system may be used for continuous auditing to provide better insights in complex markets where technology, regulation, and customer expectations are changing or are unknown. Further, the system provides ability to effectively course-correct an organic product strategy and monitor the effectiveness of the strategic or risk actions. The system may also improve the collaboration between the product and non-product teams in an organization. The disclosed system may provide a standardized reference framework for comparison and improvement. By incorporating the product heath checking within this product oversight system or framework, index changes from a high level through to a driver level can be monitored. The index and ratings can also assist with identifying areas of risk and requiring risk mitigation actions to be set.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

What is claimed is:

1. A product oversight system comprising:
an input device configured to receive a product strategy input, a related outcome input for managing a lifecycle of at least one product, and data comprising a set of domain drivers for product oversight and performance of the at least one product;
a processing device configured to:
assign a rating to the data for aggregating a score of each domain driver of the set of domain drivers;
determine a health-check index of the at least one product based on the analysis and rating of the data, and the score of each domain driver of the set of domain drivers, wherein the health-check index is determined at the product, portfolio, and business unit level with a view of achieving overall sustainable growth of product value from organic product strategy outcomes, further wherein the health-check index comprises at least one of a probability that a strategy concerning the at least one product will meet a timeline desired strategy outcome, and a probability that the strategy concerning the at least one product will undergo a life stage event or be subject to risk within a particular period of time;
rank the at least one product based on the health-check index of the at least one product;
predict a financial and value performance of the at least one product; and
simulate one or more investment scenarios and innovation actions for the at least one at least one product;
a risk management device configured to determine a risk action plan based on at least one of the health-check index, the product strategy input, and the related outcome input, wherein one or more risk mitigation activities are implemented based on the risk action plan;
a strategic management device configured to determine a strategic action plan based on the health-check index, wherein one or more strategic action activities are implemented based on the strategic action plan; and
a monitoring device configured to continuously monitor and audit the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input.

2. The product oversight system of claim 1, wherein the set of domain drivers comprising at least one of financial drivers, customer engagement drivers, market and competitive drivers, regulatory drivers, industry structure drivers, and historical insights information.

3. The product oversight system of claim 2, wherein the health-check index for the at least one product further comprises an aggregated weighted sum of ratings of the domain drivers of the at least one product.

4. The product oversight system of claim 2, wherein the processing device determines the health-check index of the at least one product using a machine learning model being trained using the historical insights information from the product oversight system.

5. The product oversight system of claim 1, wherein the monitoring device is further configured to:
monitor the lifecycle of the at least one product to see delta index changes in the health-check index of the at least one product over time;
provide a three-dimensional (3D) time-domain view across product domain driver dynamics and product strategy activities;
capture and evaluate subjective and non-subjective product knowledge; and
determine and provide at least one of an active growth strategy index, a performance feedback of the at least one product, and over performance feedback of the at least one product.

6. The product oversight system of claim 1 further comprising a database for storing information about a life stage of the at least one product, a health status comprising the health-check index of the at least one product, a plurality of hygiene factors, one or more domain driver categories with product identified, portfolio data, company data, industry data, the set of domain drivers, the related outcome input, the product strategy input, historical insights information, and the ratings and score of the set of domain drivers.

7. The product oversight system of claim 1 further comprising a display device configured to display information comprising the health-check index, the strategic action, and risk action plan.

8. The product oversight system of claim 1, wherein the strategic management device is further configured to determine an active strategy index.

9. The product oversight system of claim 1, wherein the risk management device is further configured to check if the product is meeting product regulatory obligations and other risks and accordingly provide a baseline of regulatory compliance at product level.

10. A method for product oversight by using a product oversight system, comprising:
receiving, by an input device, a product strategy input, a related outcome input for managing a lifecycle of at least one product, and data comprising a set of domain drivers for product oversight and performance of the at least one product;
assigning, by a processing device, a rating to the data for aggregating a score of each domain driver of the set of domain drivers;
determining, by the processing device, a health-check index of the at least one product based on the analysis and rating of the data, and the score of each domain driver of the set of domain drivers, wherein the health-check index is determined at the product, portfolio, and business unit level with a view of achieving overall sustainable growth of product value from organic product strategy outcomes, wherein the health-check index comprises at least one of a probability of a strategy concerning the at least one product will meet a timeline desired strategy outcome and a probability that the strategy concerning the at least one product will undergo a life stage event or be subject to risk within a particular period of time;
ranking, by the processing device, the at least one product based on the health-check index of the at least one product;
predicting, by the processing device, a financial and value performance of the at least one product;
simulating, by the processing device, one or more investment scenarios and innovation actions for the at least one at least one product;
determining, by a risk management device, a risk action plan based on at least one of the health-check index, the product strategy input, and the related outcome input, wherein one or more risk mitigation activities are implemented based on the risk action plan;
determining, by a strategic management device, a strategic action plan based on the health-check index, wherein one or more strategic action activities are implemented based on the strategic action plan;
and
continuously monitoring and auditing, by a monitoring device, the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input.

11. The method of claim 10, wherein the set of domain drivers comprising at least one of financial drivers, customer engagement drivers, market and competitive drivers, regulatory drivers, industry structure drivers, and historical insights information.

12. The method of claim 11, wherein the health-check index for the at least one product further comprises an aggregated weighted sum of ratings of the domain drivers of the at least one product.

13. The method of claim 10 further comprising determining, by the processing device, the health-check index of the at least one product using a machine learning model being trained using the historical insights information from the product oversight system.

14. The method of claim 10 further comprising:
monitoring, by the monitoring device, the lifecycle of the at least one product to see delta index changes in the health-check index of the at least one product over time;
providing, by the monitoring device, a three-dimensional (3D) time-domain view across product domain driver dynamics and product strategy activities;
capturing and evaluating, by the monitoring device, subjective and non-subjective product knowledge; and
determining and providing, by the monitoring device, at least one of an active growth strategy index, a performance feedback of the at least one product, and over performance feedback of the at least one product.

15. The method of claim 10 further comprising storing, in a database, information about a life stage of the at least one product, a health status comprising the health-check index of the at least one product, a plurality of hygiene factors, one or more domain driver categories with product identified, portfolio data, company data, industry data, the set of domain drivers, the related outcome input, the product strategy input, historical insights information, and the ratings and score of the set of domain drivers.

16. The method of claim 10 further comprising displaying, by a display device, information comprising the health-check index at the product, portfolio, and other business unit levels, the strategic action, and risk action plan.

17. The method of claim 10 further comprising determining, by the strategic management device, an active strategy index.

18. The method of claim 10 further comprising checking, by the risk management device, if the product is meeting product regulatory obligations and other risks and accordingly providing a baseline of regulatory compliance at product level.

19. A method for product oversight using a product oversight system, comprising:
receiving a product strategy input, a related outcome input for managing a lifecycle of at least one product, and data comprising a set of domain drivers for product oversight and performance of the at least one product;
assigning a rating to the data for aggregating a score of each domain driver of the set of domain drivers;
determining a health-check index of the at least one product based on the analysis and rating of the data, and the score of each domain driver of the set of domain drivers;
determining, by a risk management device of the product oversight system, a risk action plan based on at least one of the health-check index, the product strategy input, and the related outcome input, wherein one or more risk mitigation activities are implemented based on the risk action plan;
determining, by a strategic management device of the product oversight system, a strategic action plan based on the health-check index, wherein one or more strategic action activities are implemented based on the strategic action plan;
continuously monitoring and auditing the one or more the one or more implemented strategic action activities, domain drivers, implemented risk mitigation activities, and the lifecycle of the at least one product to provide continual organic planning enhancements, and monitoring of product domain driver dynamics and product strategy activities to meet a desired output according to the received related outcome input;
predicting a financial and value performance of the at least one product;
simulating one or more investment scenarios and innovation actions for the at least one at least one product; and
storing information about a life stage of the at least one product, a health status comprising the health-check index of the at least one product, a plurality of hygiene factors, one or more domain driver categories with product identified, portfolio data, company data, industry data, the set of domain drivers, the related outcome input, the product strategy input, historical insights information, the ratings and score of each domain driver of set of domain drivers.
